(19) United States
(12) Patent Application Publication
(10) Pub. No.: US 2023/0319789 A1
(43) Pub. Date: Oct. 5, 2023

(54) METHOD AND APPARATUS FOR CHANNEL STATE INFORMATION FEEDBACK IN COMMUNICATION SYSTEM

(71) Applicant: ELECTRONICS AND TELECOMMUNICATIONS RESEARCH INSTITUTE, Daejeon (KR)

(72) Inventors: Han Jun PARK, Daejeon (KR); An Seok LEE, Daejeon (KR); Heesoo LEE, Daejeon (KR); Yong Jin KWON, Daejeon (KR); Hyun Seo PARK, Daejeon (KR); Yu Ro LEE, Daejeon (KR)

(21) Appl. No.: 18/128,358

(22) Filed: Mar. 30, 2023

(30) Foreign Application Priority Data
Apr. 1, 2022 (KR) 10-2022-0040987
Mar. 14, 2023 (KR) 10-2023-0033375

(51) Int. Cl. H04W 72/04

(52) U.S. Cl. CPC H04W 72/04

(57) ABSTRACT

An operation method of a terminal in a communication system may include: receiving, from a base station, a first reference signal through a use channel; generating subchannel state information for each of a plurality of subchannels of the use channel based on the first reference signal; compressing the subchannel state information using a first neural network encoder; forming a subchannel group including at least one subchannel; generating subchannel group state information from the compressed subchannel state information of the at least one subchannel belonging to the subchannel group by using a second neural network encoder; and transmitting the subchannel group state information to the base station.

### CROSS-REFERENCE TO RELATED APPLICATIONS

This application claims priority to Korean Patent Applications No. 10-2022-0040987, filed on Apr. 1, 2022, and No. 10-2023-0033375, filed on Mar. 14, 2023, with the Korean Intellectual Property Office (KIPO), the entire contents of which are hereby incorporated by reference.

### BACKGROUND

### 1. Technical Field

Exemplary embodiments of the present disclosure relate to a technique for channel state information feedback in a communication system, and more particularly, to a channel state information feedback technique for channel state information acquisition, in which a terminal reports measured channel state information to a base station by using an intelligent encoder, and the base station acquires the channel state information by using an intelligent decoder.

### 2. Description of Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, the 3GPP is making efforts to improve a channel state information feedback method by combining recently advanced artificial intelligence (AI) and machine learning (ML) techniques with the NR radio transmission technology. In relation to these efforts, the 3GPP is recently conducting a study on how to obtain a compressed latent expression for a multiple input multiple output (MIMO) channel using an auto-encoder, one of deep learning techniques. Since such a conventional deep learning-based auto-encoder has a scheme of constructing and training an independent deep learning model for each used frequency band, it may not be efficient.

### SUMMARY

Exemplary embodiments of the present disclosure are directed to providing a channel state information feedback method and apparatus, in which a terminal measures channel state information for each subchannel unit by dividing the entire channel into a plurality of subchannels, reports the measured channel state information to a base station by using a subchannel-based intelligent encoder and a subchannel group-based intelligent encoder, and the base station acquires the channel state information by applying a subchannel-based intelligent decoder and a subchannel group-based intelligent decoder.

According to a first exemplary embodiment of the present disclosure, an operation method of a terminal in a communication system may comprise: receiving, from a base station, a first reference signal through a use channel; generating subchannel state information for each of a plurality of subchannels of the use channel based on the first reference signal; compressing the subchannel state information using a first neural network encoder; forming a subchannel group including at least one subchannel; generating subchannel group state information from the compressed subchannel state information of the at least one subchannel belonging to the subchannel group by using a second neural network encoder; and transmitting the subchannel group state information to the base station.

The generating of the subchannel group state information may comprise: generating average channel state information for the compressed channel state information of the at least one subchannel belonging to the subchannel group; generating channel state change amount information for the at least one subchannel belonging to the subchannel group; and compressing the average channel state information and the channel state change amount information for the at least one subchannel of the subchannel group using the second neural network encoder to generate the subchannel group state information.

The operation method may further comprise: before the compressing of the subchannel state information, receiving, from the base station, configuration information of the first neural network encoder; and configuring the first neural network encoder according to the configuration information of the first neural network encoder, wherein the configuration information of the first neural network encoder includes neural network model information and subchannel frequency domain resource information for the first neural network encoder.

The neural network model information may include at least one of neural network type information, type information for each layer, information on a number of neurons per layer, or inter-layer connection information.

The operation method may further comprise: before the compressing of the subchannel state information, receiving, from the base station, candidate group configuration information for the first neural network encoder; configuring a candidate group for the first neural network encoder according to the candidate group configuration information for the first neural network encoder; receiving, from the base station, indication information indicating a candidate for the first neural network encoder; and selecting the indicated candidate from the candidate group according to the indication information, and configuring the first neural network encoder according to configuration information of the selected candidate.

The operation method may further comprise: before the generating of the subchannel group state information, receiving, from the base station, configuration information of the second neural network encoder; and configuring the second neural network encoder according to the configuration information of the second neural network encoder.

The operation method may further comprise: receiving, from the base station, information on a first-stage compression result report condition; and transmitting the subchannel state information compressed using the first neural network encoder to the base station when the first-stage compression result report condition is satisfied.

The operation method may further comprise: transmitting an uplink sounding signal to the base station; receiving, from the base station, first weight vector information for the first neural network encoder based on the uplink sounding signal; and training the first neural network encoder using the first weight vector information.

The operation method may further comprise: receiving a second reference signal from the base station; generating second weight vector information for the second neural network encoder based on the second reference signal; transmitting the second weight vector information to the base station; receiving, from the base station, training configuration information for the second neural network encoder based on the second weight vector information; and training the second neural network encoder according to the training configuration information.

The operation method may further comprise: measuring interference magnitudes of basis vector directions based on the first reference signal; compressing the interference magnitudes of the basis vector directions using a third neural network encoder; and transmitting the compressed interference magnitudes to the base station.

According to a second exemplary embodiment of the present disclosure, an operation method of a base station in a communication system may comprise: transmitting a first reference signal through a use channel; receiving, from a terminal, subchannel group state information generated based on the first reference signal; restoring the subchannel group state information using a second neural network decoder to generate compressed subchannel state information of at least one subchannel belonging to a subchannel group; restoring the compressed subchannel state information using a first neural network decoder to generate subchannel state information of the at least one subchannel belonging to the subchannel group; and inferring a channel state based on the subchannel state information.

The restoring of the subchannel group state information to generate the compressed subchannel state information of the at least one subchannel belonging to the subchannel group may comprise: restoring the subchannel group state information by using the second neural network decoder, and generating average channel state information for the compressed channel state information for the at least one subchannel belonging to the subchannel group and channel state change amount information for the at least one subchannel belonging to the subchannel group; and generating channel state information of the at least one subchannel of the subchannel group by using the average channel state information and the channel state change amount information for the at least one subchannel belonging to the subchannel group.

The operation method may further comprise: generating configuration information of a first neural network encoder, the configuration information of the first neural network encoder including neural network model information for the first neural network encoder constituting a first auto-encoder with the first neural network decoder and subchannel frequency domain resource information; and transmitting the configuration information of the first neural network encoder to the terminal.

The operation method may further comprise: generating configuration information of a second neural network encoder, the configuration information of the second neural network encoder including neural network model information for the second neural network encoder constituting a second auto-encoder with the second neural network decoder and subchannel frequency domain resource information; and transmitting the configuration information of the second neural network encoder to the terminal.

The operation method may further comprise: receiving an uplink sounding signal from the terminal; generating first weight vector information for a first neural network encoder constituting a first auto-encoder with the first neural network decoder based on the uplink sounding signal; and transmitting the first weight vector information to the terminal.

The operation method may further comprise: transmitting a second reference signal to the terminal; receiving, from the terminal, second weight vector information for a second neural network encoder constituting a second auto-encoder with the second neural network decoder based on the second reference signal; generating training configuration information for the second neural network encoder based on the second weight vector information; and transmitting the training configuration information to the terminal.

The operation method may further comprise: receiving, from the terminal, information on interference magnitudes of basis vector directions, which are measured based on the first reference signal; and supplementing the inferred channel state using the information on the interference magnitudes of the basis vector directions.

According to a third exemplary embodiment of the present disclosure, an operation method of a terminal in a communication system may comprise: receiving, from a base station, training set identifier (TSI) configuration information including at least one TSI; designating an artificial intelligence model mapped to the at least one TSI according to the TSI configuration information; receiving, from the base station, training indication information including the at least one TSI; receiving, from the base station, a signal including the at least one TSI; and training the artificial intelligence model mapped to the at least one TSI based on the received signal.

The at least one TSI may be mapped to at least one physical channel in at least one beam direction.

The at least one TSI may be mapped to at least one reference signal in at least one beam direction.

According to the present disclosure, a base station and a terminal may divide an entire channel into a plurality of subchannels, and combine a subchannel-based neural network encoder and decoder and a subchannel group-based neural network encoder and decoder to configure an intelligent encoder and decoder for channel state information feedback. As a result, according to the present disclosure, an auto-encoder can reduce communication costs for neural network training by guaranteeing reusability of the subchannel-based encoder and decoder for an arbitrary system band that can be expressed in units of subchannels, and can support scalability or various system bands.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of an auto-encoder.

FIG. 4 is a conceptual diagram illustrating a first exemplary embodiment of a channel state information feedback apparatus in a communication system.

FIG. 5 is a conceptual diagram illustrating a first exemplary embodiment of a channel state information feedback method in a communication system.

FIG. 6 is a conceptual diagram illustrating a first exemplary embodiment of a method for configuring a neural network in a communication system.

FIG. 7 is a block diagram illustrating a first exemplary embodiment of the second neural network encoder and the second neural network decoder of FIG. 4.

FIG. 8 is a sequence chart illustrating a first exemplary embodiment of a method for training neural network auto-encoders in a communication system.

FIG. 9 is a sequence chart illustrating a second exemplary embodiment of a method for training neural network auto-encoders in a communication system.

FIG. 10 is a sequence chart illustrating a third exemplary embodiment of a method for training neural network auto-encoders in a communication system.

FIG. 11 is a sequence chart illustrating a fourth exemplary embodiment of a method for training neural network auto-encoders in a communication system.

FIG. 12 is a sequence chart illustrating a first exemplary embodiment of a method for transmitting channel state information and interference information in a communication system.

FIG. 13 is a conceptual diagram illustrating a first exemplary embodiment of a real part of an interference signal with respect to a basis vector direction.

FIG. 14 is a conceptual diagram illustrating a first exemplary embodiment of an imaginary part of an interference signal with respect to a basis vector direction.

FIG. 15 is a conceptual diagram illustrating a first exemplary embodiment of a method of transmitting interference information.

FIG. 16 is a conceptual diagram illustrating a second exemplary embodiment of a method of transmitting interference information.

FIG. 17 is a conceptual diagram illustrating a third exemplary embodiment of a method of transmitting interference information.

FIG. 18 is a conceptual diagram illustrating a first exemplary embodiment of an AI model training method based on a TSI.

FIG. 19 is a conceptual diagram illustrating a first exemplary embodiment of an AI model training method based on a TSI.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

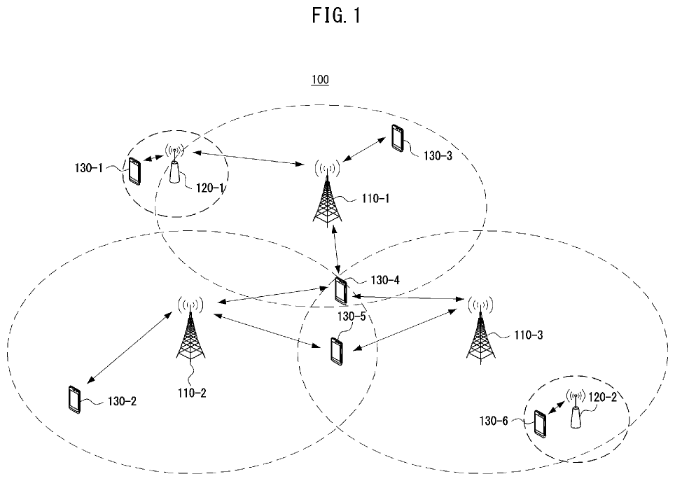

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single-carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

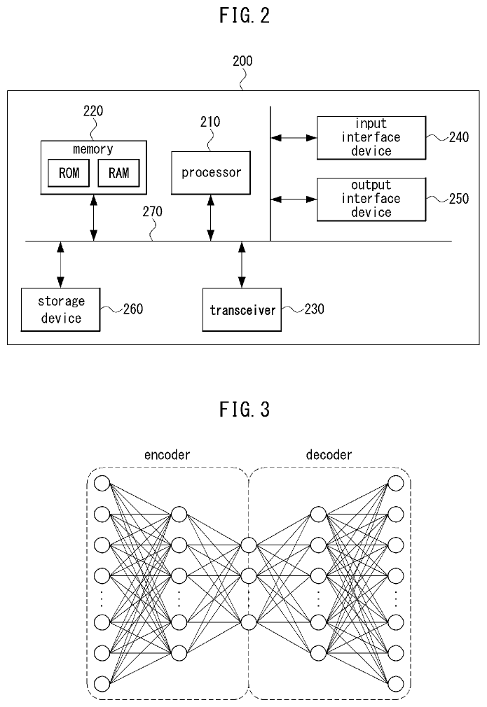

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), relay node, or the like. Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New radio (NR), etc.) defined in the 3rd generation partnership project (3GPP) specification. Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, in a mobile communication system, a transmitter may require radio channel information between the transmitter and a receiver in order to apply a transmission technique such as multiple input multiple output (MIMO) or precoding. To this end, the transmitter may acquire the radio channel information through two schemes. The first scheme among these two schemes may be referred to as ‘channel state information (CSI) feedback scheme’. In the first scheme, the transmitter may transmit a reference signal to the receiver. Then, the receiver may receive the reference signal from the transmitter, measure CSI, and report the measured CSI to the transmitter. Then, the transmitter may acquire the CSI by receiving the CSI reported from the receiver.

The second scheme may be a channel sounding scheme. In the second scheme, the receiver may transmit a reference signal to the transmitter. Then, the transmitter may receive the reference signal from the receiver, and directly measure an uplink channel using the received reference signal. Then, the transmitter may acquire CSI of a downlink channel by assuming that the measured uplink channel is identical to the downlink channel.

The NR standard defined by the 3GPP, an international standardization organization, can support both of these two channel information acquisition schemes. First, the NR standard supports feedback information such as channel quality indicator (CQI), precoding matrix indicator (PMI), and rank indicator (RI) in relation to the CSI feedback scheme. Here, the CQI may be information corresponding to a downlink signal to interference and noise power ratio (SINR), and may be expressed as a modulation and coding scheme (MCS) that meets a specific target block error rate (BLER). In addition, the PMI may be precoding information selected by the receiver, and may be expressed using a codebook predefined with the transmitter. The RI may mean the maximum number of layers of a MIMO channel. In addition, the NR standard supports a sounding reference signal (SRS), which is a reference signal for estimating an uplink channel in relation to the channel sounding scheme.

In general, in a time division duplexing (TDD) system in which reciprocity between a downlink channel and an uplink channel is guaranteed, the channel sounding scheme enables the transmitter to acquire more accurate channel information, and thus is more advantageous than the CSI feedback scheme in supporting sophisticated MIMO transmission techniques. However, the uplink reference signal used for the channel sounding scheme has a high transmission load, and as a result, there may be a limitation in that the scheme is applicable to some terminals within the network.

Therefore, the 3GPP is continuing discussions on enhancing codebooks so that precise channels can be expressed even with the CSI feedback scheme in the NR system. Specifically, the NR standard supports two types of codebooks to deliver PMI information in the NR system. In this case, the two types may be named as a type 1 code book and a type 2 code book, respectively. In the type 1 codebook, a beam group may be expressed by an oversampled DFT matrix, and one beam may be selected and transmitted from among the beam group. On the other hand, in the type 2 codebook, a plurality of beams may be selected, and information may be transmitted in form of a linear combination of the selected beams. The type 2 codebook may have a structure more suitable for supporting a transmission technique such as multi-user MIMO (MU-MIMO) compared to the type 1 codebook. However, the type 2 codebook may greatly increase a CSI feedback load according to its complex codebook structure. In relation to this problem, the 3GPP is discussing a method of evolving the CSI feedback by combining recently advanced artificial intelligence (AI) and machine learning (ML) techniques with the NR radio transmission technology in Release 18.

As a technique of applying these AI and ML techniques to the CSI feedback, a method of obtaining a compressed latent expression for a MIMO channel using an auto-encoder, which is one of recent deep learning techniques, may be used. Here, an auto-encoder may mean a neural network structure that simply copies inputs to outputs.

FIG. 3 is a conceptual diagram illustrating a first exemplary embodiment of an auto-encoder.

Referring to FIG. 3, an auto-encoder may perform data compression (or dimensionality reduction) by setting the number of neurons of hidden layer(s) between an encoder and a decoder to be smaller than that of an input layer. Such the auto-encoder may be configured based on a convolutional neural network (CNN). Such the CNN-based auto-encoder may consider a radio channel defined in the angular-delay domain as an image, and proceed with training to effectively compress CSI using the AI and ML techniques. However, when such the auto-encoder transforms a channel defined in the entire band into the angular-delay domain and applies a deep learning model that uses this as an input, a new deep learning model may need to be trained whenever a bandwidth of the channel between the transmitter and the receiver is changed.

Until recently, researches on auto-encoders have been progressing in the direction of handling a channel for the entire band as one input. For example, when this scheme is applied, a CNN-based auto-encoder for CSI feedback, which is trained in a 100 MHz NR TDD system, may not be used in a 60 MHz NR TDD system, and thus a new model suitable for a 60 MHz band may need to be configured and trained. In particular, even when a system bandwidth is fixed in the 5G NR system, a bandwidth part (BWP) configured for the terminal may be variable, which may further intensify the above-described problem. In general, costs of communication required to train a deep learning model may be enormous. Considering this point, if an independent deep learning model for each band should be constructed and trained by the auto-encoder, it may not be efficient.

In this reason, the present disclosure proposes a method of constructing an intelligent encoder/decoder for CSI feedback by dividing the entire channel into a plurality of subchannels and combining a subchannel-based neural network encoder/decoder and a subchannel group-based neural network encoder/decoder. The proposed method of the present disclosure can reduce communication costs required for training neural networks by guaranteeing reusability of the subchannel-based encoder/decoder for an arbitrary system band that can be expressed in units of subchannels, and can achieve scalability for various system bands.

For convenience of description below, a method of configuring intelligent encoder and decoder and apparatus therefor, which are proposed in the present disclosure, will be mainly described in terms of a downlink of a mobile communication system composed of a base station and a terminal. However, the proposed method of the present disclosure may be extended and applied to any wireless mobile communication system composed of a transmitter and a receiver.

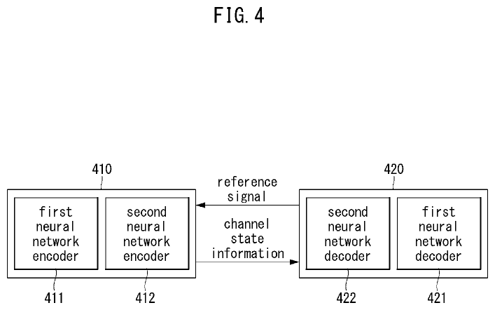

FIG. 4 is a conceptual diagram illustrating a first exemplary embodiment of a channel state information feedback apparatus in a communication system.

Referring to FIG. 4, a terminal 410 may include a first neural network encoder 411 and a second neural network encoder 412. In addition, a base station 420 may include a first neural network decoder 421 and a second neural network decoder 422. Here, the first neural network decoder 421 may operate as an auto-encoder when combined with the first neural network encoder 411. In the same manner, the second neural network decoder 422 may operate as an auto-encoder when combined with the second neural network encoder 412.

The base station 420 may transmit a reference signal to the terminal 410. Then, the terminal 410 may receive the reference signal from the base station 420, and configure channel state information by estimating a channel state. In addition, the terminal 410 may compress the channel state information by using the first neural network encoder 411 and the second neural network encoder 412, and transmit the compressed channel state information to the base station 420. Then, the base station 420 may receive the compressed channel state information, and may infer the channel state by restoring the compressed channel state information by using the first neural network decoder 421 and the second neural network decoder 422.

Here, the first neural network encoder 411 may be composed of a plurality of branch neural network encoders each of which is configured to correspond to each subchannel. Here, the plurality of branch neural network encoders may have the same structure. In this case, the plurality of branch neural network encoders may have the same weight. Alternatively, the plurality of branch neural network encoders may have different weights. Similarly, the first neural network decoder 421 may be composed of a plurality of branch neural network decoders each of which is configured to correspond to each subchannel. Here, the plurality of branch neural network decoders may have the same structure. In this case, the plurality of branch neural network decoders may have the same weight. Alternatively, the plurality of branch neural network decoders may have different weights. In this situation, the plurality of branch neural network encoders and decoders having the same weight may be configured and trained at once, so that optimization can be achieved in terms of performance.

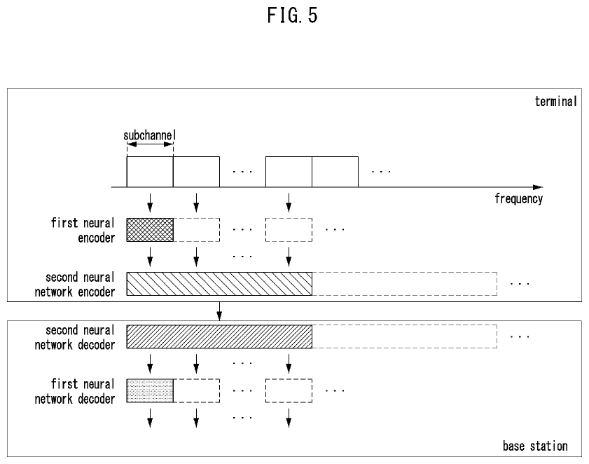

FIG. 5 is a conceptual diagram illustrating a first exemplary embodiment of a channel state information feedback method in a communication system.

Referring to FIG. 5, the base station may transmit a reference signal to the terminal using a downlink channel composed of N resource blocks (RBs). Then, the terminal 410 may receive the reference signal through the downlink channel composed of N RBs. In this case, the terminal 410 may divide the downlink channel composed of N RBs into K sub-downlink channels (i.e., subchannels). In this case, each sub-downlink channel may be composed of M consecutive RBs. Accordingly, K may be N/M. In this case, K, N, and M may be positive integers, and N>K.

The terminal may generate channel state information for each subchannel by estimating a channel state for each subchannel based on the reference signal received from the base station. Meanwhile, the first neural network encoder of the terminal may receive the channel state information for each subchannel, compress the channel state information for each subchannel into a first latent space, and output the compressed channel state information for each subchannel. In this case, it may be assumed that the subchannels are sufficiently sparse. Alternatively, a MIMO channel may be distributed at a low density relative to the entire dimension in the spatial domain of the subchannels. In this case, the first neural network encoder may serve to compress the channel state information of each subchannel defined in the spatial domain into the first latent space. That is, the first neural network encoder may compress the channel state information for each subchannel in the spatial domain.

On the other hand, the second neural network encoder of the terminal may generate subchannel groups by sequentially selecting a predetermined number of subchannels from the plurality of subchannels. Further, the second neural network encoder of the terminal may acquire channel state information for subchannels constituting each subchannel group, compresses the channel state information into a second latent space, and output the compressed channel state information for each subchannel group. In this case, it may be assumed that a frequency axis channel is sufficiently sparse. Alternatively, the channel in the frequency domain may be distributed with a low density compared to the entire dimension. In this case, the second neural network encoder may serve to compress a channel defined in the frequency domain into the second latent space. That is, the second neural network encoder may perform compression in the frequency domain.

Then, the terminal may transmit the compressed channel state information for each subchannel group to the base station. In this case, the terminal may transmit the compressed channel state information for each subchannel group to the base station through a physical channel such as a physical uplink control channel (PUCCH) or a physical uplink shared channel (PUSCH).

On the other hand, the base station may receive the compressed channel state information for each subchannel group from the terminal. Further, the second neural information for each subchannel group and output the compressed channel state information for each subchannel included in the corresponding subchannel group. Then, the first neural network decoder of the base station may restore the compressed channel state information for each subchannel, and generate and output the restored channel state information for each subchannel. Then, the base station may infer the channel state information for each subchannel from the restored channel state information for each subchannel. Accordingly, the base station may transmit a signal to the terminal using the inferred channel state information.

Here, the role performed by the first neural network encoder and the first neural network decoder may be compression in the spatial domain. In addition, the role performed by the second neural network encoder and the second neural network decoder may be compression in the frequency domain. As described above, the role performed by the first neural network encoder and the first neural network decoder and the role performed by the second neural network encoder and the second neural network decoder may be separated. Accordingly, the base station and the terminal may construct a neural network model suitable for each role. In addition, the base station and the terminal may train the neural network model suitable for each role. In addition, since the first neural network encoder and the first neural network decoder can be reused in units of subchannels, it may be easy to expand the model according to a band change, thereby reducing communication costs for model parameters (or weights).

Meanwhile, the second neural network encoder may take the compressed channel state information output from the first neural network encoder for a plurality of subchannels constituting each subchannel group as input data, and compress them into the second latent space. In this case, the second neural network encoder may generate average channel state information for the compressed channel state information of the plurality of subchannels constituting each subchannel group. In addition, the second neural network encoder may generate channel state change amount information indicating a change in the compressed channel state information for each subchannel relative to the average channel state information of the subchannel group to which the subchannels constituting the subchannel group belong. Thereafter, the second neural network encoder may separately compress the average channel state information for each of the plurality of the subchannel groups and the channel state change amount information for each of the subchannels belonging to each of the plurality of the subchannel groups relative to the average channel state information thereof. Accordingly, the terminal may transmit, to the base station, the compressed average channel state information for each subchannel group and channel state change amount information for each of the subchannels belonging to each subchannel group relative to the average channel state information thereof.

On the other hand, the base station may receive the compressed average channel state information for each subchannel group and channel state change amount information for each of the subchannels belonging to each subchannel group relative to the average channel state information thereof. In addition, the second neural network decoder of the base station may restore the compressed average channel state information and channel state change amount information, and output the average channel state information for each subchannel group and the channel state change amount information for each of the subchannels belonging thereto. Then, the first neural network decoder of the base station may generate the compressed channel state information for each subchannel based on the restored average channel state information and channel state change amount information. In addition, the first neural information for each subchannel to generate and output the restored channel state information for each subchannel. Then, the base station may infer the channel state for each subchannel from the restored channel state information for each subchannel. Accordingly, the base station may transmit a signal to the terminal using the inferred channel state information.

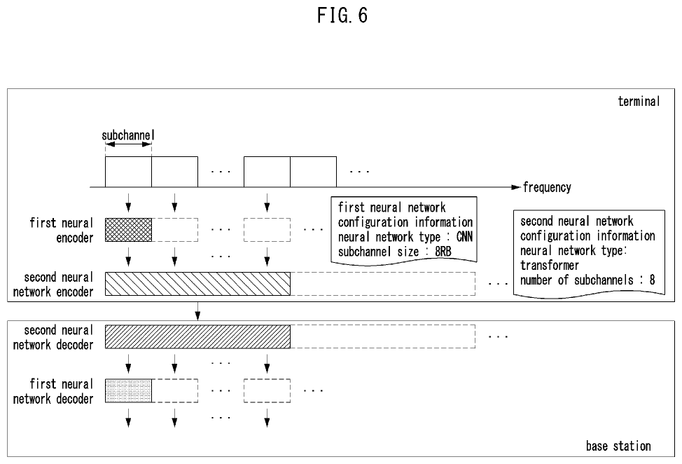

FIG. 6 is a conceptual diagram illustrating a first exemplary embodiment of a method for configuring a neural network in a communication system.

Referring to FIG. 6, the base station may transmit configuration information for the first neural network encoder and configuration information for the second neural network encoder to the terminal independently. Specifically, the configuration information for the first neural network encoder may include subchannel frequency domain resource information together with neural network model information. In addition, the configuration information for the second neural network encoder may include subchannel group information together with neural network model information. Here, the neural network model information may include neural network type information, type information for each layer, information on the number of neurons for each layer, information on connections between layers, and the like. In this case, the type information for each layer may include convolution product information, fully-connected layer information, and the like. Further, the subchannel frequency domain resource information may include information of the size of an RB group when a subchannel is defined as a subband. In addition, the subchannel group information may include information on the number of subchannels constituting a subchannel group.

Meanwhile, the base station may transmit the configuration information for the first neural network encoder and the configuration information for the second neural network encoder to the terminal using a higher layer signal. Here, the higher layer signal may be a radio resource control (RRC) signaling or a media access control (MAC) control element (CE). Alternatively, the base station may transmit the configuration information for the first neural network encoder and the configuration information for the second neural network encoder to the terminal using a dynamic control signal. Here, the dynamic control signal may be downlink control information (DCI). Accordingly, the terminal may receive, from the base station, the configuration information for the first neural network encoder and the configuration information for the second neural network encoder independently. Then, the terminal may configure the first neural network encoder according to the received configuration information for the first neural network encoder, and configure the second neural network encoder according to the received configuration information for the second neural network encoder.

Alternatively or additionally, the base station may transmit configuration information of a candidate group for the first neural network encoder and configuration information of a candidate group for the second neural network encoder to the terminal using a higher layer signal. Specifically, the configuration information of the candidate group for the first neural network encoder may include subchannel frequency domain resource information of candidates together with neural network model information of the candidates. In addition, the configuration information of the candidate group for the second neural network encoder may include subchannel group information of candidates together with neural network model information of the candidates. Accordingly, the terminal may receive, from the base station, the configuration information of the candidate group for the first neural network encoder and the configuration information of the candidate group for the second neural network encoder independently. Then, the terminal may configure a first neural network encoder candidate group according to the received configuration information of the candidate group for the first neural network encoder. In addition, the terminal may configure a second neural network encoder candidate group according to the received configuration information of the candidate group for the second neural network encoder. Thereafter, the base station may transmit indication information indicating a specific candidate in the candidate group for the first neural network encoder to the terminal using a dynamic control signal. In addition, the base station may transmit indication information indicating a specific candidate in the candidate group for the second neural network encoder to the terminal using a dynamic control signal. Accordingly, the terminal may independently receive the indication information indicating the specific candidate for the first neural network encoder and the indication information indicating the specific candidate for the second neural network encoder from the base station. Then, the terminal may configure the first neural network encoder according to the candidate indicated by the received indication information for the first neural network encoder, and configure the second neural network encoder according to the candidate indicated by the received indication information for the second neural network encoder.

For example, in a mobile communication system composed of a base station and a terminal, such as the 5G NR system according to the 3GPP standard, the base station may use a higher layer signal such as RRC signaling to the terminal to configure a neural network model of the first neural network encoder as a convolutional neural network (CNN) model. In addition, the base station may configure the terminal to set the size of a subchannel (or subband) to 8 consecutive RBs using a higher layer signal such as RRC signaling. In addition, the base station may configure the terminal to configure a neural network model of the second neural network encoder as a transformer (TR) model using a higher layer signal such as RRC signaling. In addition, the base station may configure the terminal to receive an output of the first neural network encoder corresponding to 8 consecutive subchannels (or subbands) as an input by using a higher layer signal such as RRC signaling. For example, in the case of performing channel state information feedback for a total of 256 RBs, when the terminal follows the above-described configuration, the first neural network encoder may be applied for each subchannel (or subband) consisting of 8 RBs to obtain 32 output value(s), and the second neural network encoder may be applied to each subchannel group comprising 8 subchannels to generate four pieces of compressed channel state information in the second latent space.

In the above-described situation, the terminal may receive the configuration information for the first neural network encoder from the base station, but may not receive the configuration information for the second neural network encoder from the base station. Alternatively, the terminal may receive the configuration information of the candidate group for the first neural network encoder from the base station, but may not receive the configuration information of the candidate group for the second neural network encoder from the base station. Alternatively, the terminal may receive the indication information indicating the candidate for the first neural network encoder from the base station, but may not receive the indication information indicating the candidate for the second neural network encoder from the base station. In this case, the terminal may regard the output of the first neural network encoder for each subchannel as channel state information for each subchannel, collect the channel state information for all subchannels, and provide feedback to the base station. Then, the base station may receive compressed channel state information for each subchannel from the terminal. The first neural network decoder of the base station may restore the compressed channel state information for each subchannel, and generate and output the restored channel state information for each subchannel. Then, the base station may infer the channel state for each subchannel from the restored channel state information for each subchannel. Accordingly, the base station may transmit a signal to the terminal using the inferred channel state information.

Meanwhile, the terminal may not receive the configuration information for the first neural network encoder and the configuration information for the second neural network encoder from the base station. Alternatively, the terminal may not receive the configuration information of the candidate group for the first neural network encoder and the configuration information of the candidate group for the second neural network encoder from the base station. Alternatively, the terminal may not receive the indication information indicating the candidate for the first neural network encoder and the indicating information indicating the candidate for the second neural network encoder from the base station. In this case, the terminal may transmit channel state information generated by applying the conventional channel state information feedback scheme to the base station without a compression process. Then, the base station may receive the uncompressed channel state information for each subchannel from the terminal, and may infer the channel state of each subchannel from the restored channel state information of each subchannel. Accordingly, the base station may transmit a signal to the terminal using the inferred channel state information.

As described above, the base station or the network may independently configure the first neural network and the second neural network, so that when changing the neural network model, the entire model may not be changed. As a result, the base station or network may quickly construct an updated first neural network or second neural network by changing a part of the first neural network or the second neural network.

Meanwhile, the base station may configure the terminal to transmit the channel state information compressed by the first neural network encoder when a preconfigured condition is satisfied. To this end, the base station may generate a first-stage result report request control signal including a first-stage result report condition and a first-stage result report indicator. Here, the first-stage result report condition may correspond to a case where training of the second neural network encoder is not completed. Alternatively, the first-stage result report condition may correspond to a case where a channel restoration capability of the second neural network encoder is lower than expected. The base station may transmit the first-stage result report request control signal including the first-stage result report condition and the first-stage result report indicator to the terminal. Then, the terminal may receive the first-stage result report request control signal from the base station, and may obtain the first-stage result report condition and the first-stage result report indicator.

When the first-stage result report condition is satisfied, the terminal may derive channel state information for each subchannel by applying the first neural network encoder in units of subchannels. In addition, the terminal may report the channel state information to the base station in units of subchannels for all subchannels within a channel state information feedback band. Then, the base station may receive the compressed channel state information for each subchannel from the terminal, and may infer the channel state of each subchannel from the restored channel state information of each subchannel. Accordingly, the base station may transmit a signal to the terminal using the inferred channel state information.

Alternatively, when the first-stage result report condition is satisfied, the terminal may derive channel state information for each subchannel by applying the first neural network encoder in units of subchannels. In addition, the terminal may transmit the subchannel-based channel state information to the base station for a representative subchannel within the channel state information feedback band. Then, the base station may receive the compressed channel state information of the representative subchannel from the terminal, and may infer the channel state of the representative subchannel from the restored channel state information of the representative subchannel. Accordingly, the base station may transmit a signal to the terminal using the inferred channel state information.

Alternatively, when the first-stage result report condition is satisfied, the terminal may derive channel state information for each subchannel by applying the first neural network encoder in units of subchannels. In addition, the terminal may transmit channel state information to the base station for several representative subchannels within the channel state information feedback band. Then, the base station may receive the compressed channel state information of the several representative subchannels from the terminal, and may infer the channel states of the representative subchannels from the restored channel state information of the representative subchannels. Accordingly, the base station may transmit a signal to the terminal using the inferred channel state information.

Alternatively, when the first-stage result report condition is satisfied, the terminal may select a representative channel for the entire channel. In this case, the representative channel may be a subchannel having channel state information closest to average channel state information of the entire channel. Accordingly, the terminal may compress channel state information of the representative subchannel by applying the first neural network encoder to the representative subchannel, and transmit the compressed channel state information of the representative subchannel to the base station. The base station may receive the compressed channel state information of the representative subchannel from the terminal, and may infer the channel state from the restored channel state information of the representative subchannel. Accordingly, the base station may transmit a signal to the terminal using the inferred channel state information.

Alternatively, when the first-stage result report condition is satisfied, the terminal may calculate average channel state information for the entire channel. Accordingly, the terminal may compress the average channel state information by applying the first neural network encoder, and transmit the compressed average channel state information to the base station. The base station may receive the compressed average channel state information from the terminal, and may infer channel states from the restored average channel state information by restoring the compressed average channel state information. Accordingly, the base station may transmit a signal to the terminal using the inferred channel state information.

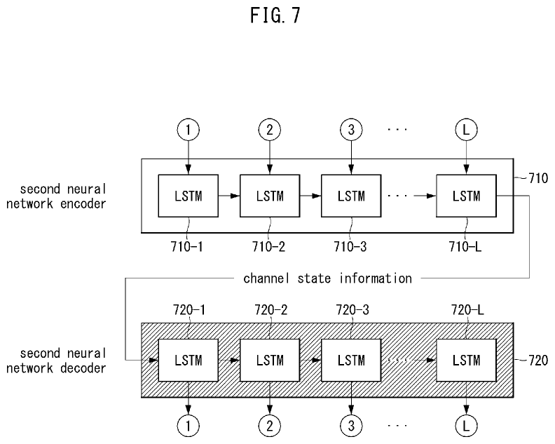

FIG. 7 is a block diagram illustrating a first exemplary embodiment of the second neural network encoder and the second neural network decoder of FIG. 4.

Referring to FIG. 7, the second neural network encoder 710 may be configured by long short-term memory (LSTM) cells 710-1 to 710-L in which a part responsible for long-term memory are added to a recurrent neural network (RNN) model in series. An input length of the LSTM cells 710-1 to 710-L may be L. Here, L may be a positive integer. The second neural network encoder 710 may be a sequence-to-sequence (Seq2Seq) model that takes L output values of the first neural network encoder as inputs.

In addition, the second neural network decoder 720 may be configured by connecting LSTM cells 720-1 to 720-L in which a part responsible for long-term memory is added to an RNN model in series. An output length of the LSTM cells 720-1 to 720-L may be L.

Meanwhile, the base station may generate configuration information for the input length L of the second neural network encoder of the terminal. The base station may transmit the configuration information for the input length L of the second neural network encoder to the terminal. In this case, the base station may transmit the configuration information for the input length L of the second neural network encoder to the terminal using a higher layer signal. Here, the higher layer signals may be an RRC signaling and/or a MAC control element. Alternatively, the base station may transmit the configuration information for the input length L of the second neural network encoder to the terminal using a dynamic control signal. Here, the dynamic control signal may be DCI. Accordingly, the terminal may receive the configuration information for the input length L of the second neural network encoder from the base station, and may set the input length L of the second neural network encoder according to the received configuration information for the input length L of the second neural network encoder.

Meanwhile, the base station may generate configuration information of a candidate group for the input length L of the second neural network encoder of the terminal. Here, the configuration information of the candidate group for the input length L may include candidate values of several candidates for the input length L. The base station may transmit the configuration information of the candidate group for the input length L of the second neural network encoder to the terminal. In this case, the base station may transmit the configuration information of the candidate group for the input length L of the second neural network encoder to the terminal using a higher layer signal and/or a dynamic control signal. Accordingly, the terminal may receive the configuration information of the candidate group for the input length L of the second neural network encoder from the base station, and may obtain the candidate values of the candidates of the input length L of the second neural network encoder according to the received configuration information of the candidate group for the input length L of the second neural network encoder.

Thereafter, the base station may designate a candidate for the input length L of the second neural network encoder to the terminal, and may transmit indication information indicating the candidate for the input length L of the second neural network encoder to the terminal. In this case, the base station may transmit the indication information indicating the candidate for the input length L of the second neural network encoder to the terminal using a dynamic control signal. Accordingly, the terminal may receive the indication information indicating the candidate for the input length L of the second neural network encoder from the base station, obtain a candidate value of the designated candidate from the candidate values for the input length L of the second neural network encoder according to the indication information for the input length L of the received second neural network encoder, and designate it as the input length L.

Meanwhile, the sequence-to-sequence based second neural network encoder may receive compressed channel state information for each of L subchannels from the first neural network encoder, and may output compressed channel state information by compressing the L pieces of compressed channel state information into one context vector. Here, the compressed channel state information may be a channel state context vector. In this case, the terminal may control a maximum compression rate 1/L by controlling the maximum input length L. Thereafter, the terminal may transmit the channel state information compressed into one context vector to the base station. Then, the base station may receive the channel state information compressed into one context vector from the terminal. In addition, the second neural network decoder of the base station may restore the channel state information compressed into one context vector, and output the compressed channel state information of the L subchannels to the first neural network decoder. Accordingly, the first neural network decoder may restore the compressed channel state information of the L subchannels. The base station may infer the channel state of each subchannel from the restored channel state information of each subchannel. Accordingly, the base station may transmit a signal to the terminal using the inferred channel state information.

As described above, when the terminal wants to compress the frequency axis channel using the second neural network encoder, the maximum compression rate may be explicitly controlled. In addition, due to the characteristics of the sequence-to-sequence model, a recurrent neural network constituting the second neural network encoder and the second neural network decoder may be expressed with a weight for a single memory cell (or RNN cell). As a result, the terminal and the base station can reduce communication costs required in the process of exchanging configuration information of the second neural network encoder and decoder models.

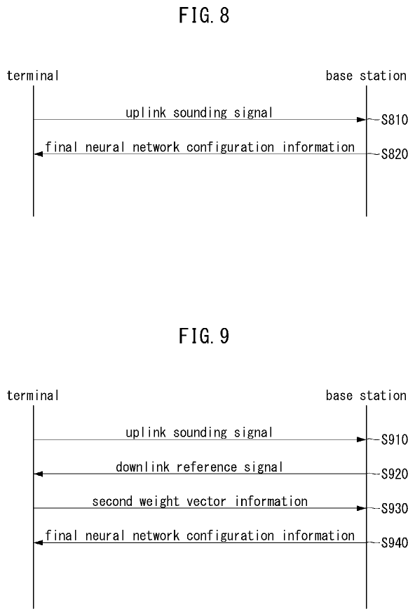

FIG. 8 is a sequence chart illustrating a first exemplary embodiment of a method for training neural network auto-encoders in a communication system.

Referring to FIG. 8, the terminal may transmit an uplink sounding signal to the base station (S810). Then, the base station may receive the uplink sounding signal from the terminal, and may generate first weight vector information for the first neural network encoder based on the received uplink sounding signal. In addition, the base station may generate second weight vector information for the second neural network encoder based on the received uplink sounding signal. For example, in a TDD communication system, the base station may acquire uplink channel state information based on the received uplink sounding signal, and may transpose the acquired uplink channel state information and regard the transposed uplink channel information as downlink channel information. Here, the TDD communication system may be a mobile communication system in which reciprocity between a downlink channel and an uplink channel is guaranteed.

Thereafter, the base station may train the first neural network encoder using the first weight vector information, and may determine final first neural network encoder configuration information (i.e., configuration information for finally configuring the first neural network encoder). That is, the base station may update weight vector information of the first neural network encoder using the first weight vector information, and may determine the final first neural network encoder configuration information accordingly. In this case, the final first neural network encoder configuration information may be the first weight vector information. In addition, the final first neural network encoder configuration information may be training configuration information of the first neural network encoder. In addition, the base station may train the second neural network encoder using the second weight vector information, and may determine final second neural network encoder configuration information (i.e., configuration information for finally configuring the second neural network encoder). That is, the base station may update weight vector information of the second neural network encoder using the second weight vector information, and may determine the final second neural network encoder configuration information accordingly. Here, the final second neural network encoder configuration information may be the second weight vector information. In addition, the final second neural network encoder configuration information may be training configuration information of the second neural network encoder. The base station may transmit the final first neural network encoder configuration information and the final second neural network encoder configuration information to the terminal (S820).

In this case, the base station may transmit the final first neural network encoder configuration information and the final second neural network encoder configuration information independently. The base station may transmit the final first neural network encoder configuration information and the final second neural network encoder configuration information to the terminal by using system information. Alternatively, the base station may transmit the final first neural network encoder configuration information and the final second neural network encoder configuration information to the terminal using a broadcast channel. Alternatively, the base station may transmit the final first neural network encoder configuration information and the final second neural network encoder configuration information to the terminal using a higher layer signal. The terminal may receive the final first neural network encoder configuration information and the final second neural network encoder configuration information from the base station. The terminal may update the first neural network encoder using the final first neural network encoder configuration information. That is, the terminal may train the first neural network encoder using the final first neural network encoder configuration information. In addition, the terminal may update the second neural network encoder using the final second neural network encoder configuration information. That is, the terminal may train the second neural network encoder using the final second neural network configuration information.

In this case, the terminal may update the first neural network encoder by using the first weight vector information when the final first neural network encoder configuration information is the first weight vector information. That is, the terminal may train the first neural network encoder using the first weight vector information. In addition, when the final second neural network encoder configuration information is the second weight vector information, the terminal may update the second neural network encoder using the second weight vector information. That is, the terminal may train the second neural network encoder using the second weight vector information.

FIG. 9 is a sequence chart illustrating a second exemplary embodiment of a method for training neural network auto-encoders in a communication system.

Referring to FIG. 9, the terminal may transmit an uplink sounding signal to the base station (S910). Then, the base station may receive the uplink sounding signal from the terminal, and may generate first weight vector information for the first neural network encoder based on the received uplink sounding signal. For example, in a TDD communication system, the base station may acquire uplink channel state information based on the received uplink sounding signal, and may transpose the acquired uplink channel state information and regard the transposed uplink channel information as downlink channel information. Here, the TDD communication system may be a mobile communication system in which reciprocity between a downlink channel and an uplink channel is guaranteed. Thereafter, the base station may train the first neural network encoder using the first weight vector information, and may determine final first neural network encoder configuration information (i.e., configuration information for finally configuring the first neural network encoder). In this case, the final first neural network encoder configuration information may be the first weight vector information.

Meanwhile, the base station may transmit a downlink reference signal to the terminal (S920). Then, the terminal may receive the downlink reference signal from the base station and may calculate second weight vector information for the second neural network encoder. The terminal may transmit the calculated second weight vector information to the base station (S930). Accordingly, the base station may receive the second weight vector information, use it to train the second neural network encoder, and determine final second neural network encoder configuration information (i.e., configuration information for finally configuring the second neural network encoder). Here, the final second neural network encoder configuration information may be the second weight vector information.

The base station may transmit the final first neural network encoder configuration information and the final the second neural network encoder configuration information to the terminal (S940). In this case, the base station may transmit the final first neural network encoder configuration information and the final second neural network encoder configuration information independently. The base station may transmit the final first neural network encoder configuration information and the final second neural network encoder configuration information to the terminal by using system information. Alternatively, the base station may transmit the final first neural network encoder configuration information and the final second neural network encoder configuration information to the terminal using a broadcast channel. Alternatively, the base station may transmit the final first neural network encoder configuration information and the final second neural network encoder configuration information to the terminal using a higher layer signal. The terminal may receive the final first neural network encoder configuration information and the final second neural network encoder configuration information from the base station. The terminal may update the first neural network encoder using the final first neural network encoder configuration information. In addition, the terminal may update the second neural network encoder using the final second neural network encoder configuration information.

In this case, the terminal may update the first neural network encoder by using the first weight vector information when the final first neural network encoder configuration information is the first weight vector information. That is, the terminal may train the first neural network encoder using the first weight vector information. In addition, when the final second neural network encoder configuration information is the second weight vector information, the terminal may update the second neural network encoder using the second weight vector information. That is, the terminal may train the second neural network encoder using the second weight vector information.

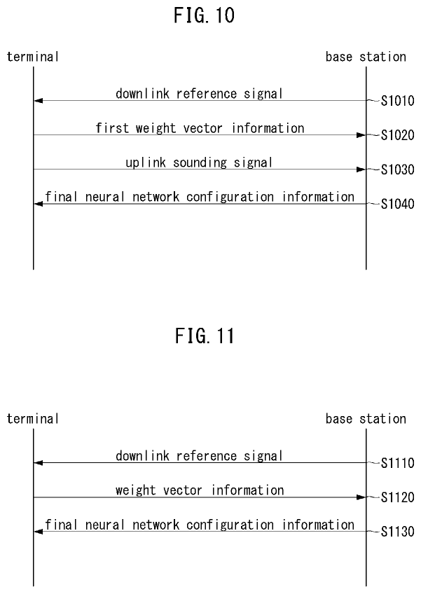

FIG. 10 is a sequence chart illustrating a third exemplary embodiment of a method for training neural network auto-encoders in a communication system.

Referring to FIG. 10, the base station may transmit a downlink reference signal to the terminal (S1010). Then, the terminal may receive the downlink reference signal from the base station, and may calculate first weight vector information for the first neural network encoder. The terminal may transmit the calculated first weight vector information to the base station (S1020). Accordingly, the base station may receive the first weight vector information, use it to train the first neural network encoder, and determine final first neural network encoder configuration information (i.e., configuration information for finally configuring the first neural network encoder). In this case, the final first neural network encoder configuration information may be the first weight vector information.

Meanwhile, the terminal may transmit an uplink sounding signal to the base station (S1030). Then, the base station may receive the uplink sounding signal from the terminal. The base station may generate second weight vector information for the second neural network encoder based on the received uplink sounding signal. For example, in a TDD communication system, the base station may acquire uplink channel state information based on the received uplink sounding signal. The base station may transpose the acquired uplink channel state information and regard the transposed uplink channel information as downlink channel information. Here, the TDD communication system may be a mobile communication system in which reciprocity between a downlink channel and an uplink channel is guaranteed. Thereafter, the base station may train the second neural network encoder using the second weight vector information, and may determine final second neural network encoder configuration information (i.e., configuration information for finally configuring the second neural network encoder). In this case, the final second neural network encoder configuration information may be the second weight vector information.

The base station may transmit the final first neural network encoder configuration information and the final the second neural network encoder configuration information to the terminal (S1040). In this case, the base station may transmit the final first neural network encoder configuration information and the final second neural network encoder configuration information independently. The base station may transmit the final first neural network encoder configuration information and the final second neural network encoder configuration information to the terminal by using system information. Alternatively, the base station may transmit the final first neural network encoder configuration information and the final second neural network encoder configuration information to the terminal using a broadcast channel. Alternatively, the base station may transmit the final first neural network encoder configuration information and the final second neural network encoder configuration information to the terminal using a higher layer signal. The terminal may receive the final first neural network encoder configuration information and the final second neural network encoder configuration information from the base station. The terminal may update the first neural network encoder using the final first neural network encoder configuration information. In addition, the terminal may update the second neural network encoder using the final second neural network encoder configuration information.

In this case, the terminal may update the first neural network encoder by using the first weight vector information when the final first neural network encoder configuration information is the first weight vector information. That is, the terminal may train the first neural network encoder using the first weight vector information. In addition, when the final second neural network encoder configuration information is the second weight vector information, the terminal may update the second neural network encoder using the second weight vector information. That is, the terminal may train the second neural network encoder using the second weight vector information.

FIG. 11 is a sequence chart illustrating a fourth exemplary embodiment of a method for training neural network auto-encoders in a communication system.

Referring to FIG. 11, the base station may transmit a downlink reference signal to the terminal (S1110). Then, the terminal may receive the downlink reference signal from the base station, and may calculate first weight vector information for the first neural network encoder. In addition, the terminal may receive the downlink reference signal from the base station, and may calculate second weight vector information for the second neural network encoder. The terminal may transmit the calculated first weight vector information and second weight vector information to the base station (S1120). In this case, the terminal may transmit the calculated first weight vector information and second weight vector information to the base station independently. Accordingly, the base station may receive the first weight vector information, use it to train the first neural network encoder, and determine final first neural network encoder configuration information (i.e., configuration information for finally configuring the first neural network encoder). In this case, the final first neural network encoder configuration information may be the first weight vector information. In addition, the base station may receive the second weight vector information, use it to train the second neural network encoder, and determine final second neural network encoder configuration information (i.e., configuration information for finally configuring the second neural network encoder). In this case, the final second neural network encoder configuration information may be the second weight vector information.

The base station may transmit the final first neural network encoder configuration information and the final the second neural network encoder configuration information to the terminal (S1130). In this case, the base station may transmit the final first neural network encoder configuration information and the final second neural network encoder configuration information independently. The base station may transmit the final first neural network encoder configuration information and the final second neural network encoder configuration information to the terminal by using system information. Alternatively, the base station may transmit the final first neural network encoder configuration information and the final second neural network encoder configuration information to the terminal using a broadcast channel. Alternatively, the base station may transmit the final first neural network encoder configuration information and the final second neural network encoder configuration information to the terminal using a higher layer signal. The terminal may receive the final first neural network encoder configuration information and the final second neural network encoder configuration information from the base station. The terminal may update the first neural network encoder using the final first neural network encoder configuration information. In addition, the terminal may update the second neural network encoder using the final second neural network encoder configuration information.

In this case, the terminal may update the first neural network encoder by using the first weight vector information when the final first neural network encoder configuration information is the first weight vector information. That is, the terminal may train the first neural network encoder using the first weight vector information. In addition, when the final second neural network encoder configuration information is the second weight vector information, the terminal may update the second neural network encoder using the second weight vector information. That is, the terminal may train the second neural network encoder using the second weight vector information.

As described above, when the base station leads or assists training with the uplink channel information, communication costs can be greatly reduced compared to a method in which a plurality of terminals feedback weight vectors after training.

Meanwhile, optimal precoding for maximizing a data rate in the MIMO-based mobile communication system may vary depending on noise and interference experienced by the receiver as well as channel information between the transmitter and the receiver. In this case, information for determining precoding may not be sufficient when only channel information is fed back, such as in the auto-encoder-based CSI feedback technique. In order to solve this problem, the present disclosure may propose a method of additional feedback of interference information capable of assisting the AI-based channel information feedback. For example, the interference information may mean an average direction and a magnitude of interference measured by the terminal. The terminal may report such the indirect information to the base station at a longer periodicity than the channel information. In this case, a time and frequency resource used to report the channel information and a time and frequency resource used to report the interference information may be the same. Alternatively, the resource used to report the channel information and the resource used to report the interference information may be independent from each other.

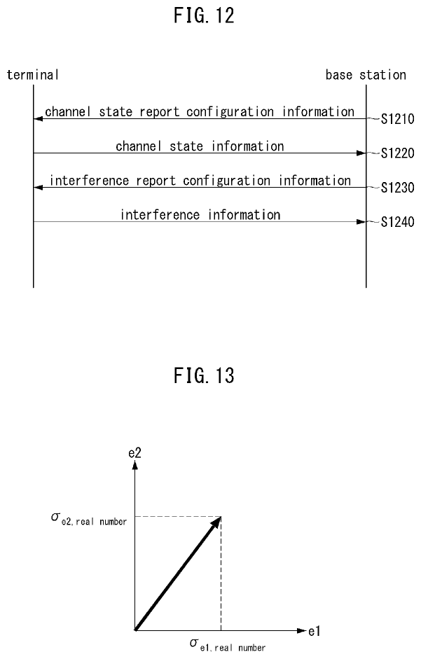

FIG. 12 is a sequence chart illustrating a first exemplary embodiment of a method for transmitting channel state information and interference information in a communication system.

Referring to FIG. 12, the base station may allocate a time and frequency resource to be used by the terminal to report channel state information, and may generate channel state report configuration information including information on the allocated time and frequency resource. Then, the base station may transmit the generated channel state report configuration information to the terminal (S1210). The terminal may receive the channel state report configuration information from the base station. Then, the terminal may transmit the channel state information to the base station using the time and frequency resource according to the received channel state report configuration information (S1220). The base station may receive the channel state information from the terminal to determine a channel state.

Meanwhile, the base station may allocate a time and frequency resource to be used by the terminal to report interference information, and may generate interference report configuration information including information on the allocated time and frequency. Then, the base station may transmit the generated interference report configuration information to the terminal (S1230). The terminal may receive the interference report configuration information from the base station. Then, the terminal may transmit interference information to the base station using the time and frequency resource according to the received interference report configuration information (S1240). The base station may receive the interference information from the terminal to determine the channel state. As described above, the base station may transmit the channel state report configuration information and the interference report configuration information to the terminal independently. However, the base station may generate channel state feedback configuration information by combining the channel state report configuration information and the interference report configuration information, and may transmit the channel state feedback configuration information to the terminal. Then, the terminal may receive the channel state feedback configuration information including the channel state report configuration information and the interference report configuration information from the base station. The terminal may separate the channel state report configuration information and the interference report configuration information from the received channel state feedback configuration information.

Accordingly, the terminal may transmit the channel state information to the base station using the time and frequency resource according to the separated channel state report configuration information. Accordingly, the base station may receive the channel state information from the terminal to determine the channel state. In addition, the terminal may transmit the interference information to the base station using the time and frequency resource according to the separated interference report configuration information. The base station may receive the interference information from the terminal and determine an interference state. Meanwhile, the channel state information may be instantaneous information, and the interference information may be average information.

Meanwhile, when the number of transmit antennas of the base station is N_{T} and the number of receive antennas of the terminal is N_{R}, the interference information may be information on an interference magnitude corresponding to a direction of a basis vector having N_{R} dimensions for each of a real part and an imaginary part. N_{T} and N_{R} may be positive integers. Here, the basis vector direction may be a standard basis vector direction. In addition, the basis vector direction may be determined according to a scheme agreed in advance between the base station and the terminal. Next, the information on the interference magnitude corresponding to the basis vector direction may be information on an interference magnitude of the entire channel. Alternatively, the information on the interference magnitude may be information on an interference magnitude in a subchannel unit. For example, the information on the interference magnitude may be information on an interference magnitude for each subchannel. In this case, the terminal may transmit the information on the interference magnitude corresponding to the basis vector direction to the base station independently of the channel state information. As described above, when transmitting the information on the interference magnitude corresponding to the basis vector direction to the base station, the terminal may quantize the information on the interference magnitude for each basis vector direction. In addition, the terminal may transmit, to the base station, the information the quantized interference magnitude for each basis vector direction.

Then, the base station may receive the information on the quantized interference magnitude for each basis vector direction, and use the information for estimating a channel state or the like. In addition, the terminal may configure a neural network encoder and a neural network decoder for the purpose of feedbacking interference information independently of the neural network encoder and the neural network decoder for the purpose of feedbacking channel state information. Here, the neural network encoder and the neural network decoder for the purpose of feedbacking interference information may be an auto-encoder for the purpose of feedbacking interference information. Accordingly, when transmitting information on the interference magnitude corresponding to the basis vector direction to the base station, the terminal may compress the information on the interference magnitude for each basis vector direction by using the neural network encoder. In addition, the terminal may transmit to the base station information on the compressed interference magnitude for each basis vector direction. Then, the base station may receive the information on the compressed interference magnitude for each basis vector direction, and restore it using the neural network decoder. In addition, the base station may use the restored interference magnitude information for each basis vector direction to estimate a channel state or the like. A detailed description of a process in which the terminal delivers interference information to the base station may be as follows.

According to an exemplary embodiment of the present disclosure, when the terminal can feedback channel information to the base station using the deep learning-based CSI feedback method, the terminal may additionally report interference information capable of assisting the channel state information to the base station. In this case, the terminal may regard the channel as a linear transform for a MIMO OFDM-based mobile communication system in which the number of transmit antennas is N_{T} and the number of receive antennas is N_{R}, and may report the information on the interference magnitude for each basis vector direction at a region of the receive antennas. For example, when N_{R}=2, the terminal may regard [0 1]^{T}, [1 0]^{T}, j*[0 1]^{T}, and j*[1 0]^{T} as standard basis vector directions on the coordinate plane. In addition, the terminal may calculate a variance of an interference signal by using N bits for each basis vector direction. Thereafter, the terminal may transmit information on the variance of the interference signal calculated for each basis vector direction to the base station. Accordingly, the base station may receive, from the terminal, information on the variance of the interference signal, which is calculated for each basis vector direction. In addition, the base station may evaluate an interference effect according to the precoding technique by utilizing the received information on the variance of the interference signal for each basis vector direction.

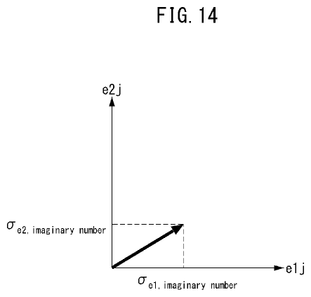

FIG. 13 is a conceptual diagram illustrating a first exemplary embodiment of a real part of an interference signal with respect to a basis vector direction.

Referring to FIG. 13, basis vector directions may be [0 1]^{T} and [1 0]^{T} in the real coordinate plane. In this case, one basis vector direction [0 1]^{T} may be expressed as e1, and the other basis vector direction [1 0]^{T} may be expressed as e2. In this case, a variance of an interference signal in the one basis vector direction e1 may be σ_{e1,real number}. A variance of the interference signal in the other basis vector direction e2 may be σ_{e2,real number}.

FIG. 14 is a conceptual diagram illustrating a first exemplary embodiment of an imaginary part of an interference signal with respect to a basis vector direction.

Referring to FIG. 14, basis vector directions may be j*[0 1]^{T} and j*[1 0]^{T} in the imaginary coordinate plane. In this case, one basis vector direction j*[0 1]^{T} may be expressed as e1j, and the other basis vector direction j*[1 0]^{T} may be expressed as e2j. In this case, a variance of an interference signal in the one basis vector direction e1j may be σ_{e1, imaginary number}. A variance of an interference signal in the other basis vector direction e2j may be σ_{e2, imaginary number}.

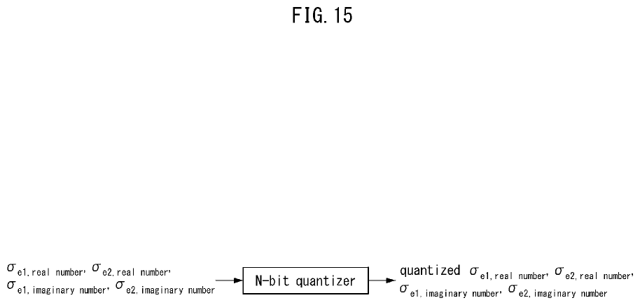

FIG. 15 is a conceptual diagram illustrating a first exemplary embodiment of a method of transmitting interference information.

Referring to FIG. 15, the terminal may use an N-bit quantizer 1510 to quantize the variance σ_{e1,real number} of the interference signal in the basis vector direction e1, the variance σ_{e2,real number} of the interference signal in the basis vector direction e2, the variance σ_{e1,imaginary number} of the interference signal in the basis vector direction e1j, and the variance σ_{e2,imaginary number} of the interference signal in the basis vector direction e2j.

Further, the terminal may deliver, to the base station, the quantized variance σ_{e1,real number} of the interference signal in the basis vector direction e1, variance σ_{e2,real number} of the interference signal in the basis vector direction e2, variance σ_{e1,imaginary number} of the interference signal in the basis vector direction e1j, and variance σ_{e2,imaginary number} of the interference signal in the basis vector direction e2j. Then, the base station may receive, from the terminal, the quantized variance σ_{e1,real number} of the interference signal in the basis vector direction e1, variance σ_{e2,real number} of the interference signal in the basis vector direction e2, variance σ_{e1,imaginary number} of the interference signal in the basis vector direction e1j, and variance σ_{e2,imaginary number} of the interference signal in the basis vector direction e2j. In addition, the base station may evaluate an interference effect according to the precoding technique by utilizing the received variances of the interference signals of the basis vector directions.

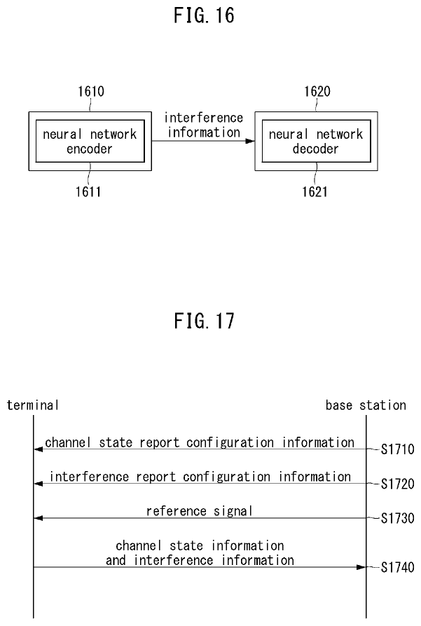

FIG. 16 is a conceptual diagram illustrating a second exemplary embodiment of a method of transmitting interference information.

Referring to FIG. 16, the terminal 1610 may use a neural network encoder 1611 to compress the variance σ_{e1,real number} of the interference signal in the basis vector direction e1, variance σ_{e2,real number} of the interference signal in the basis vector direction e2, variance σ_{e1,imaginary number} of the interference signal in the basis vector direction e1j, and variance σ_{e2,imaginary number} of the interference signal in the basis vector direction e2j.

In addition, the terminal may deliver, to the base station 1620, the compressed variance σ_{e1,real number} of the interference signal in the basis vector direction e1, variance σ_{e2,real number} of the interference signal in the basis vector direction e2, variance σ_{e1,imaginary number} of the interference signal in the basis vector direction e1j, and variance σ_{e2,imaginary number} of the interference signal in the basis vector direction e2j. Then, the base station may receive, from the terminal, the compressed variance σ_{e1,real number} of the interference signal in the basis vector direction e1, variance σ_{e2,real number} of the interference signal in the basis vector direction e2, variance σ_{e1,imaginary number} of the interference signal in the basis vector direction e1j, and variance σ_{e2,imaginary number} of the interference signal in the basis vector direction e2j. In addition, the base station may restore the received variances of the interference signals of the basis vector directions by using a neural network decoder 1621. In addition, the base station may evaluate the interference effect according to the precoding technique by utilizing the restored variances of the interference signals of the basis vector directions.

Meanwhile, in an environment in which a specific interference pattern is frequently observed, the terminal may apply a method of compressing interference information using the neural network encoder. In this regard, the neural network encoder and the neural network decoder for interference information feedback may be trained as follows in the base station. First, prior to training the neural network encoder and the neural network decoder for interference information feedback, the terminal may feedback explicit interference information to the base station by applying a quantization process. The base station may receive the interference information from one or more terminals. Then, the base station may configure the received interference information as a training data set. The base station may construct the neural network encoder and the neural network decoder for interference information feedback for a specific terminal or a specific terminal group. Thereafter, the base station may train the constructed neural network encoder and neural network decoder using the configured training data set. The base station may transmit configuration information of the trained neural network encoder to the terminal. Then, the terminal may install the neural network encoder by receiving the configuration information of the trained neural network encoder from the base station.

FIG. 17 is a conceptual diagram illustrating a third exemplary embodiment of a method of transmitting interference information.

Referring to FIG. 17, the base station may allocate a time and frequency resource to be used by the terminal to report channel state information. The base station may generate channel state report configuration information including information on the allocated time and frequency resource. Then, the base station may transmit the generated channel state report configuration information to the terminal (S1710). The terminal may receive the channel state report configuration information from the base station.

Meanwhile, the base station may allocate a time and frequency resource to be used by the terminal to report interference information. The base station may generate interference report configuration information including information on the allocated time and frequency resource. Then, the base station may transmit the generated interference report configuration information to the terminal (S1720). The terminal may receive the interference report configuration information from the base station.

Thereafter, the base station may transmit a reference signal to the terminal using a downlink channel composed of N RBs (S1730). Then, the terminal may receive the reference signal through the downlink channel composed of N RBs. In this case, the terminal may divide the downlink channel composed of N RBs into K sub-downlink channels (i.e., subchannels). In this case, each sub-downlink channel may be composed of M consecutive RBs. Accordingly, K may be N/M. In this case, K, N, and M may be positive integers, and N>K.

The terminal may generate channel state information for each subchannel by estimating a channel state for each subchannel by receiving the reference signal from the base station. In addition, the terminal may generate interference information for each basis vector direction by receiving the reference signal from the base station and measuring an interference magnitude for each basis vector direction for the entire channel or for each of the subchannels.

Meanwhile, the neural network encoder of the terminal may receive the channel state information for each subchannel and the interference information for each basis vector direction, compress them into a latent space, and output the compressed channel state information for each subchannel and the compressed interference information for each basis vector direction. Then, the terminal may transmit the compressed channel state information for each subchannel and the compressed interference information for each basis vector direction to the base station. In this case, the terminal may feedback the compressed channel state information and the interference information to the base station through a physical channel such as PUCCH or PUSCH (S1740).

The base station may receive the compressed channel state information for each subchannel and the compressed interference information for each basis vector direction from the terminal. In addition, the neural network decoder of the base station may restore the compressed channel state information for each subchannel and the compressed interference information for each basis vector direction, and output the restored channel state information for each subchannel and the restored interference information for each basis vector direction. Then, the base station may infer a channel state of each subchannel from the restored channel state information of each subchannel and the restored interference information of each basis vector direction. Accordingly, the base station may transmit a signal to the terminal using the inferred CSI.

Meanwhile, the terminal and the base station may apply an AI model to the first auto-encoder in a process of transmitting and receiving mobile communication data. In addition, the terminal and the base station may apply an AI model to the second auto-encoder in a process of transmitting and receiving mobile communication data. In this situation, the terminal and the base station may apply one or more AI models to the same function in consideration of various antenna shapes and channel environments of commercial networks. However, even when the terminal has capability to operate a plurality of AI models for a specific function, if physical channels or reference signals to be used for training cannot be distinguished, the plurality of AI models cannot be separately trained and applied.

Accordingly, in the present disclosure, the base station may configure training set identifiers (TSIs) corresponding to physical channels or reference signals. Here, the TSI may be a transmission configuration indication (TCI) for quasi-colocation (QCL) information. Alternatively, the TSI may be one or more TCIs for QCL information.

For example, the base station may assign a TSI for each of physical channels and/or reference signals for each beam direction within a cell or for each transmission and reception point (TRP). Here, the physical channels may be physical downlink shared channels (PDSCHs), physical downlink control channels (PDCCHs), and the like. The reference signals may be demodulation reference signals (DMRSs), channel state information-reference signals (CSI-RSs), and the like.

As another example, the base station may divide 24 hours in which a user's use pattern is repeated into a plurality of time periods. Then, the base station may configure TSIs for physical channels and/or reference signals for the respective time periods.

The base station may generate configuration information of the TSIs. The base station may transmit the generated configuration information of the TSIs to the terminal. Accordingly, the terminal may receive the configuration information of the TSIs from the base station. The terminal may designate an AI model for each TSI according to the received configuration information of the TSIs.

Then, as an example, the base station may transmit indication information (i.e., TSI indication information) indicating a TSI for at least one beam direction or at least one physical channel and/or at least one reference signal of at least one TRP to the terminal. Then, the terminal may receive the TSI indication information for at least one beam direction or at least one physical channel and/or at least one reference signal of at least one TRP from the base station. Accordingly, the terminal may train an independent AI model for each beam direction or TRP based on the received TSI indication information. In addition, the terminal may apply an independent AI model for each beam direction or TRP based on the received TSI indication information.

As another example, the base station may transmit TSI indication information of at least one beam direction or at least one physical channel and/or at least one reference signal of at least one TRP for a time period desired to train to the terminal. Then, the terminal may receive the TSI indication information of at least one beam direction or at least one physical channel and/or at least one reference signal of at least one TRP for a time period desired to train from the base station. Accordingly, the terminal may train an independent AI model for each beam direction or TRP based on the received TSI indication information for the time period desired to train. In addition, the terminal may apply an independent AI model for each beam direction or TRP based on the received TSI indication information for the time period desired to train.

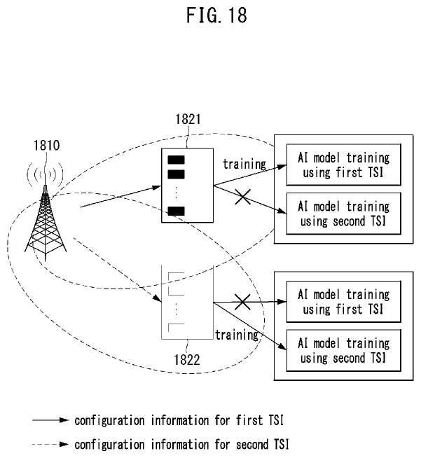

FIG. 18 is a conceptual diagram illustrating a first exemplary embodiment of an AI model training method based on a TSI.

Referring to FIG. 18, a base station 1810 may generate first TSI indication information (i.e., information indicating a first TSI) for training an AI model for a first terminal 1821. In addition, the base station 1810 may transmit the first TSI indication information to the first terminal 1821 by using a higher layer signal. Here, the higher layer signal may be an RRC signaling and a MAC CE. Alternatively, the base station 1810 may transmit the first TSI indication information to the first terminal 1821 using a dynamic control signal. Accordingly, the first terminal 1821 may receive the first TSI indication information from the base station 1810. Then, the first terminal 1821 may train the AI model for the first TSI according to the received first TSI indication information. In addition, the first terminal 1821 may apply the AI model for the first TSI according to the received first TSI indication information.

Alternatively, the base station 1810 may generate a first TSI candidate group by selecting TSIs for training AI models for the first terminal 1821. In this case, the first TSI candidate group may include the first TSI. In addition, the base station 1810 may generate configuration information of the first TSI candidate group for training AI models for the first terminal 1821. Then, the base station 1810 may transmit the configuration information of the first TSI candidate group to the first terminal 1821 by using a higher layer signal. Accordingly, the first terminal 1821 may receive the configuration information of the first TSI candidate group from the base station 1810. Further, the first terminal 1821 may configure the first TSI candidate group according to the received configuration information of the first TSI candidate group. Thereafter, the base station 1810 may transmit indication information indicating the first TSI in the first TSI candidate group to the first terminal 1821 by using a dynamic control signal. Accordingly, the first terminal 1821 may receive the indication information indicating the first TSI in the first TSI candidate group from the base station 1810. Further, the first terminal 1821 may training the AI model for the first TSI according to the received indication information indicating the first TSI. In addition, the first terminal 1821 may apply the AI model for the first TSI indicated according to the received indication information indicating the first TSI.

Meanwhile, the base station 1810 may generate second TSI indication information (i.e., information indicating a second TSI) for training an AI model for a second terminal 1821, and may transmit the second TSI indication information to the second terminal 1822 using a higher layer signal. Here, the higher layer signal may be an RRC signaling or a MAC CE. Alternatively, the base station 1810 may transmit the second TSI indication information to the second terminal 1822 using a dynamic control signal. Accordingly, the second terminal 1822 may receive the second TSI indication information from the base station 1810. The second terminal 1822 may train the AI model for the second TSI according to the received second TSI indication information. In addition, the second terminal 1822 may apply the AI model for the second TSI according to the received second TSI indication information.

Alternatively, the base station 1810 may generate a second TSI candidate group by selecting TSIs for training AI models for the second terminal 1822. In this case, the second TSI candidate group may include the second TSI. In addition, the base station 1810 may generate configuration information of the second TSI candidate group for training the AI models for the second terminal 1822. Then, the base station 1810 may transmit the configuration information of the second TSI candidate group to the second terminal 1822 by using a higher layer signal. Accordingly, the second terminal 1822 may receive the configuration information of the second TSI candidate group from the base station 1810. Further, the second terminal 1822 may configure the second TSI candidate group according to the received configuration information of the second TSI candidate group. Thereafter, the base station 1810 may transmit indication information indicating the second TSI in the second TSI candidate group to the second terminal 1822 by using a dynamic control signal. Accordingly, the second terminal 1822 may receive the indication information indicating the second TSI in the second TSI candidate group from the base station 1810. Further, the second terminal 1822 may train the AI model for the second TSI according to the received indication information indicating the second TSI. In addition, the second terminal 1822 may apply the AI model for the second TSI indicated according to the received indication information indicating the second TSI.

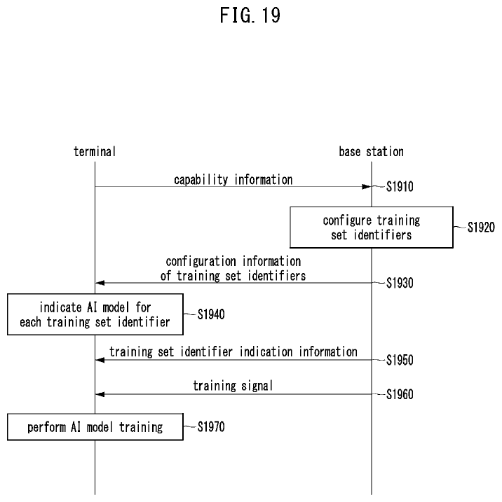

FIG. 19 is a conceptual diagram illustrating a first exemplary embodiment of an AI model training method based on a TSI.

Referring to FIG. 19, the terminal may transmit capability information to the base station by including information on the number of supportable TSIs in the capability information (S1910). In this case, the terminal may report, to the base station, information on the number of supportable TSIs for each function or category to which an AI model is applied. Then, the base station may receive the capability information including the information on the number of supportable TSIs from the terminal. The base station may identify the information on the number of supportable TSIs in the received capability information. In this case, the base station may identify the information on the number of TSIs supported by the terminal for each function or category to which the AI model is applied.

The base station may configure TSIs corresponding to physical channels or reference signals based on the capability information received from the terminal (S1920). Here, the TSI may be a TCI for QCL information. Alternatively, the TSI may be one or more TCIs for QCL information. In this case, the base station may configure a TSI for each of physical channels and/or reference signals for each beam direction within a cell or for each TRP. Here, the physical channels may be PDSCHs, PDCCHs, and the like.

In addition, the reference signals may be DMRSs, CSI-RSs, and the like. As another example, the base station may divide 24 hours in which a user's use pattern is repeated into a plurality of time periods, and may configure TSIs of physical channels and/or reference signals for the respective time periods.

For example, the terminal may set the number of TSIs supportable for each beam direction to 4, and report it to the base station. Then, the base station may identify the number of TSIs supported by the terminal as 4 for each beam direction. In addition, the base station may map a TSI 1 to a PDSCH, map a TSI 2 to a PDCCH, map a TSI 3 to a DMRS, and map a TSI 4 to a CSI-RS for each of the beam directions.

Alternatively, the terminal may set the number of TSIs supportable for each TRP to 4, and report it to the base station. Then, the base station may identify the number of TSIs supported by the terminal as 4 for each TRP. In addition, the base station may map a TSI 1 to a PDSCH, map a TSI 2 to a PDCCH, map a TSI 3 to a DMRS, and map a TSI 4 to a CSI-RS for each TRP.

Alternatively, the terminal may set the number of TSIs supportable for each time period to 4, and report it to the base station. Then, the base station may identify the number of TSIs supported by the terminal as 4 for each time period. In addition, the base station may map a TSI 1 to a PDSCH, map a TSI 2 to a PDCCH, map a TSI 3 to a DMRS, and map a TSI 4 to a CSI-RS for each time period.

Thereafter, the base station may generate configuration information of the TSIs. Here, the configuration information of the TSIs may include information of beam identifiers (IDs) for distinguishing the respective beam directions and information on the TSIs mapped thereto. Alternatively, the configuration information of the TSIs may include information on TRP IDs for distinguishing the respective TRPs and information on the TSIs mapped thereto. Alternatively, the configuration information of the TSIs may include period information for distinguishing the respective time periods and information on the TSIs mapped thereto.

Meanwhile, the base station may transmit the generated configuration information of the TSIs to the terminal (S1930). Accordingly, the terminal may receive the configuration information of the TSIs from the base station. The terminal may designate an AI model for each TSI according to the received configuration information of the TSIs (S1940).

Thereafter, the base station may transmit indication information indicating a TSI of at least one beam direction or at least one physical channel and/or reference signal of at least one TRP desired to train to the terminal (S1950). Then, the terminal may receive the indication information indicating the TSI of at least one beam direction or at least one physical channel and/or reference signal of at least one TRP from the base station. In this case, the base station may transmit the indication information indicating the TSI to the terminal using a higher layer signal. Here, the higher layer signal may be an RRC signaling or a MAC CE. Alternatively, the base station may transmit the indication information indicating the TSI to the terminal using a dynamic control signal.

Alternatively, the base station may generate a TSI candidate group by selecting TSIs for training AI models for the terminal. In this case, the TSI candidate group may include a specific TSI. In addition, the base station may generate configuration information of the TSI candidate group for training AI models for the terminal. Then, the base station may transmit the configuration information of the TSI candidate group to the terminal by using a higher layer signal.

Accordingly, the terminal may receive the configuration information of the TSI candidate group from the base station. Further, the terminal may configure the TSI candidate group according to the received configuration information of the TSI candidate group. Thereafter, the base station may transmit indication information indicating the specific TSI in the TSI candidate group to the terminal by using a dynamic control signal. Accordingly, the terminal may receive the indication information indicating the specific TSI in the TSI candidate group from the base station. Further, the terminal may training an AI model for the specific TSI according to the received indication information indicating the specific TSI. In addition, the terminal may apply the AI model for the specific TSI indicated according to the received indication information indicating the specific TSI.

Thereafter, the base station may transmit a training signal to the terminal by including a TSI corresponding to a physical channel or reference signal desired to train in the training signal (S1906). For example, the base station may transmit the training signal to the terminal by including a TSI mapped to at least one beam direction or at least one physical channel and/or reference signal of at least one TRP desired to train in the training signal. Then, the terminal may receive, from the base station, the training signal including the mapped TSI.

Accordingly, the terminal may train an AI model corresponding to the TSI included in the received training signal (S1970). In addition, the terminal may apply the AI model corresponding to the TSI included in the received training signal.

As described above, the exemplary embodiment of the present disclosure provide a method of configuring the intelligent encoder and decoder for CSI feedback by dividing the entire channel into a plurality of subchannels and combining the subchannel-based first neural network encoder and decoder and the subchannel group-based second neural network encoder and decoder. The advantages of applying the intelligent encoder and decoder proposed in the present disclosure are largely as follows.

First, the exemplary embodiment of the present disclosure can support adaptability to an environment in which a reception bandwidth is changed. For example, when the reception bandwidth is changed, the subchannel-based first neural network encoder and decoder can be reused, and thus the neural network encoder and decoder for CSI feedback suitable for the changed bandwidth can be quickly updated. In addition, as in another proposed method of the present disclosure, when the second neural network encoder and decoder are configured in a sequence-to-sequence based model capable of processing variable inputs, since the same sequence-to-sequence model can be applied even if the number of subchannel groups is changed due to a change in the bandwidth, the second neural network encoder and decoder can also be reused.

Second, the exemplary embodiment of the present disclosure can support independent neural network construction and/or training for each subchannel unit and each subchannel group unit. For example, the subchannel-based first neural network encoder and decoder may be designed to effectively compress a channel in the spatial domain into a low-dimensional space. The subchannel group-based second neural network encoder and decoder may be designed to effectively compress a channel in the frequency domain into a low-dimensional space. In addition, by combining the first neural network encoder and decoder and training them as an auto-encoder and combining the second neural network encoder and decoder and training them as an auto-encoder, the neural network that needs to be updated can be specified and trained.

Third, the exemplary embodiment of the present disclosure can support supplementation of auto-encoder-based channel state information feedback. For example, when the terminal feeds back channel state information based on the auto-encoder, pure channel information can be extracted into a latent space and transmitted to the base station. In the present disclosure, average interference information paired with AI-based pure channel information can be reported to the base station. Accordingly, the base station can apply more diverse MIMO techniques.

Fourth, the exemplary embodiment of the present disclosure can support independent AI model training and application for each commercial channel environment for the same function. For example, the base station may configure TSIs, which are training data set identifiers classified according to analog beam directions within a cell with respect to physical channel(s) and/or reference signal(s), and transmit information thereof to the terminal. Then, the terminal can perform training and application of an AI model for each TSI in a process such as data demodulation within a range allowed by the terminal's capability. In this case, the terminal may operate concisely only based on the parameter called TSI. As a result, the base station can achieve an effect of training and applying the AI model by the terminal for each analog beam direction by correspondingly operating the analog beam direction and the TSI.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An operation method of a terminal in a communication system, comprising:
receiving, from a base station, a first reference signal through a use channel;
generating subchannel state information for each of a plurality of subchannels of the use channel based on the first reference signal;
compressing the subchannel state information using a first neural network encoder;
forming a subchannel group including at least one subchannel;
generating subchannel group state information from the compressed subchannel state information of the at least one subchannel belonging to the subchannel group by using a second neural network encoder; and
transmitting the subchannel group state information to the base station.

2. The operation method according to claim 1, wherein the generating of the subchannel group state information comprises:
generating average channel state information for the compressed channel state information of the at least one subchannel belonging to the subchannel group;
generating channel state change amount information for the at least one subchannel belonging to the subchannel group; and
compressing the average channel state information and the channel state change amount information for the at least one subchannel of the subchannel group using the second neural network encoder to generate the subchannel group state information.

3. The operation method according to claim 1, further comprising: before the compressing of the subchannel state information,
receiving, from the base station, configuration information of the first neural network encoder; and
configuring the first neural network encoder according to the configuration information of the first neural network encoder,
wherein the configuration information of the first neural network encoder includes neural network model information and subchannel frequency domain resource information for the first neural network encoder.

4. The operation method according to claim 3, wherein the neural network model information includes at least one of neural network type information, type information for each layer, information on a number of neurons per layer, or inter-layer connection information.

5. The operation method according to claim 1, further comprising: before the compressing of the subchannel state information,
receiving, from the base station, candidate group configuration information for the first neural network encoder;
configuring a candidate group for the first neural network encoder according to the candidate group configuration information for the first neural network encoder;
receiving, from the base station, indication information indicating a candidate for the first neural network encoder; and
selecting the indicated candidate from the candidate group according to the indication information, and configuring the first neural network encoder according to configuration information of the selected candidate.

6. The operation method according to claim 1, further comprising: before the generating of the subchannel group state information,
receiving, from the base station, configuration information of the second neural network encoder; and
configuring the second neural network encoder according to the configuration information of the second neural network encoder.

7. The operation method according to claim 1, further comprising:
receiving, from the base station, information on a first-stage compression result report condition; and
transmitting the subchannel state information compressed using the first neural network encoder to the base station when the first-stage compression result report condition is satisfied.

8. The operation method according to claim 1, further comprising:
transmitting an uplink sounding signal to the base station;
receiving, from the base station, first weight vector information for the first neural network encoder based on the uplink sounding signal; and
training the first neural network encoder using the first weight vector information.

9. The operation method according to claim 1, further comprising:
receiving a second reference signal from the base station;
generating second weight vector information for the second neural network encoder based on the second reference signal;
transmitting the second weight vector information to the base station;
receiving, from the base station, training configuration information for the second neural network encoder based on the second weight vector information; and
training the second neural network encoder according to the training configuration information.

10. The operation method according to claim 1, further comprising:
measuring interference magnitudes of basis vector directions based on the first reference signal;
compressing the interference magnitudes of the basis vector directions using a third neural network encoder; and
transmitting the compressed interference magnitudes to the base station.

11. An operation method of a base station in a communication system, comprising:
transmitting a first reference signal through a use channel;
receiving, from a terminal, subchannel group state information generated based on the first reference signal;
restoring the subchannel group state information using a second neural network decoder to generate compressed subchannel state information of at least one subchannel belonging to a subchannel group;
restoring the compressed subchannel state information using a first neural network decoder to generate subchannel state information of the at least one subchannel belonging to the subchannel group; and
inferring a channel state based on the subchannel state information.

12. The operation method according to claim 11, wherein the restoring of the subchannel group state information using the second neural network decoder to generate the compressed subchannel state information of the at least one subchannel belonging to the subchannel group comprises:
restoring the subchannel group state information by using the second neural network decoder, and generating average channel state information for the compressed channel state information for the at least one subchannel belonging to the subchannel group and channel state change amount information for the at least one subchannel belonging to the subchannel group; and
generating channel state information of the at least one subchannel of the subchannel group by using the average channel state information and the channel state change amount information for the at least one subchannel belonging to the subchannel group.

13. The operation method according to claim 11, further comprising:
generating configuration information of a first neural network encoder, the configuration information of the first neural network encoder including neural network model information for the first neural network encoder constituting a first auto-encoder with the first neural network decoder and subchannel frequency domain resource information; and
transmitting the configuration information of the first neural network encoder to the terminal.

14. The operation method according to claim 11, further comprising:
generating configuration information of a second neural network encoder, the configuration information of the second neural network encoder including neural network model information for the second neural network encoder constituting a second auto-encoder with the second neural network decoder and subchannel frequency domain resource information; and
transmitting the configuration information of the second neural network encoder to the terminal.

15. The operation method according to claim 11, further comprising:
receiving an uplink sounding signal from the terminal;
generating first weight vector information for a first neural network encoder constituting a first auto-encoder with the first neural network decoder based on the uplink sounding signal; and
transmitting the first weight vector information to the terminal.

16. The operation method according to claim 11, further comprising:
transmitting a second reference signal to the terminal;
receiving, from the terminal, second weight vector information for a second neural network encoder constituting a second auto-encoder with the second neural network decoder based on the second reference signal;
generating training configuration information for the second neural network encoder based on the second weight vector information; and
transmitting the training configuration information to the terminal.

17. The operation method according to claim 11, further comprising:
receiving, from the terminal, information on interference magnitudes of basis vector directions, which are measured based on the first reference signal; and
supplementing the inferred channel state using the information on the interference magnitudes of the basis vector directions.

18. An operation method of a terminal in a communication system, comprising:
receiving, from a base station, training set identifier (TSI) configuration information including at least one TSI;
designating an artificial intelligence model mapped to the at least one TSI according to the TSI configuration information;
receiving, from the base station, training indication information including the at least one TSI;
receiving, from the base station, a signal including the at least one TSI; and
training the artificial intelligence model mapped to the at least one TSI based on the received signal.

19. The operation method according to claim 18, wherein the at least one TSI is mapped to at least one physical channel in at least one beam direction.

20. The operation method according to claim 18, wherein the at least one TSI is mapped to at least one reference signal in at least one beam direction.
